(19) United States
(12) Patent Application Publication
(10) Pub. No.: US 2012/0013776 A1
(43) Pub. Date: Jan. 19, 2012

(54) CAMERA WITH AT LEAST TWO IMAGE SENSOR SETS

(76) Inventors: Chia-Jung Tsou, Taipei (TW); Chun-Hsiang Chao, (US)

(21) Appl. No.: 12/837,520

(22) Filed: Jul. 16, 2010

(51) Int. Cl. H04N 5/202

(52) U.S. Cl. 348/254; 348/E05.074

(57) ABSTRACT

A camera with at least two image sensor sets includes an aperture; a lens set for capturing images; at least two image sensing sets; each image sensor array having a plurality of image sensors which are arranged as an array for receiving external images; each image sensor receives a part of the image, which is a pixel; an image is formed by a plurality of pixels which are arranged as an array of M×N pixel; an image signal processing module receiving all the image arrays from the image sensor arrays which are presented as analog signals; the image processor module converting the analog signals into digital signals which are so called gray levels of respective pixels so as to get digital image arrays; and an image processor for processing the data of the digital image arrays and combining the images to have a new image with higher resolution.

### FIELD OF THE INVENTION

The present invention relates to image quality, and in particular to a camera with at least two image sensor sets which provide high quality images, while only prior sensor device is used. The number of sensors in each image sensor set is retained. Thus the overall cost is lower than those using a sensor device with a large amount of sensors for getting the same image quality.

### BACKGROUND OF THE INVENTION

To have high resolution image has become a trend in the requirement of image quality. Then the resolution of image is increased. To get a high resolution image, more sensors (such as CCD sensors or COMS sensors) are concentrated as a sensor array for capturing an image. However, this induces a difficulty in manufacturing, but also the cost increases dramatically.

Further all prior art cameras are equipped on sensor array for capturing images. Then the captured image is processed in an image processor so as to have a preferred image quality.

### SUMMARY OF THE INVENTION

The object of the present invention is to provide a camera with at least to image sensor device for capturing high quality image. In processing the images, image overlapping, integration and interpolation are used to have high quality images. Only prior sensor device is used. The number of sensors in the sensor device are retained. Thus the overall cost is lower than those using a sensor device with a large amount of sensors for getting the same image quality.

To achieve above object, the present invention provides a camera with at least two image sensor sets, comprising; an aperture for receiving external light; a lens set for capturing external images; at least two image sensing sets; each image sensor array including a plurality of image sensors which are arranged as an array for receiving external images; each image sensor receives a part of the image, which is a pixel; an image is formed by a plurality of pixels which are arranged as an array of M×N pixel; an image signal processing module receiving all the image arrays from the image sensor arrays which are presented as analog signals; the image processor module converting the analog signals into digital signals which are so called gray levels of respective pixels so as to get first digital image array; each gray level represents the shade of a color; and an image processor connected to the image processor module; the image processor processing the data of the digital image arrays and combining the images to have a new image with higher resolution; a memory connected to the image processor module and the image processor for data storage and storing related processing software; a display for displaying images from the image processor; and an output device connected to the image processor for outputting images from the image processor.

Furthermore, the image processor processing the data of the digital image arrays and combining the images to have a new image with higher resolution by the steps of: overlapping the digital image arrays with each other; where line overlapping or surface overlapping can be used; integrating all the digital image arrays are integrated; that is, a composite image is formed by the image processor; in that, the digital image arrays being expanded by filling space pixels into the pixels of the image array and then all the expanded digital image arrays are alternatively arranged; defining the gray levels of the space pixels, in that the values of the gray levels of the space pixels are determined by the gray levels of the pixels adjacent to the space pixels;

The various objects and advantages of the present invention will be more readily understood from the following detailed description when read in conjunction with the appended drawing.

### BRIEF DESCRIPTION OF THE DRAWINGS

FIG. 1 shows the hardware structure of the present invention.

FIG. 2 shows the processing flow diagram of the present invention.

FIG. 3 shows the aspect relation about the two sensor arrays in the present invention.

FIG. 4 shows the first step in the integration of the digital image arrays according to the present invention.

FIG. 5 shows the second step in the integration of the digital image arrays according to the present invention.

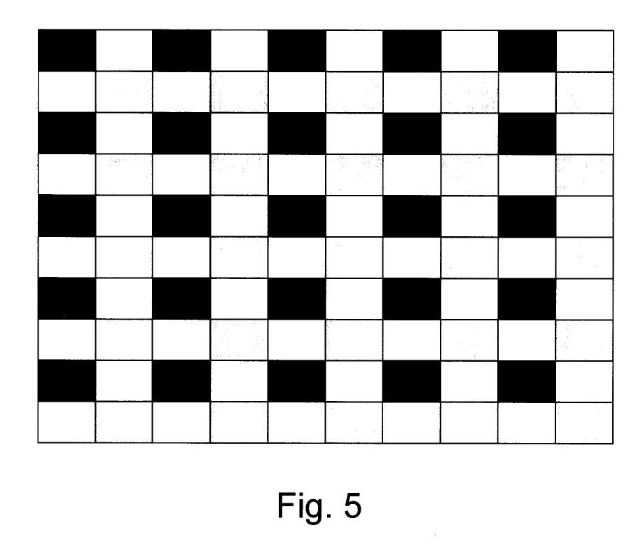

FIG. 6 shows the processing flow diagram of the present invention, where plural image sensors are used.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

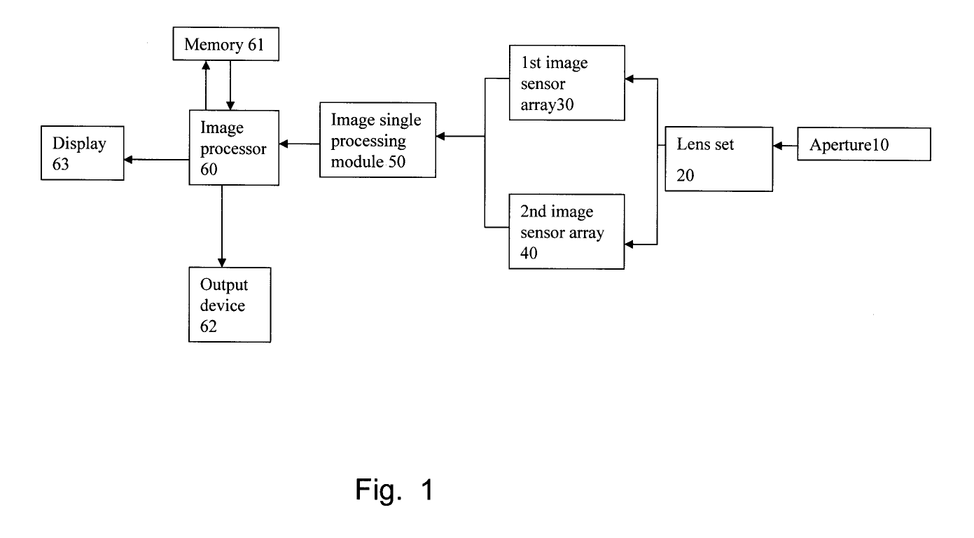

With reference to FIG. 1, a camera with two sensor sets for improving image quality according to the present invention is illustrated. The present invention includes the following elements of:

An aperture 10 for receiving external light;

A lens set 20 for capturing external images;

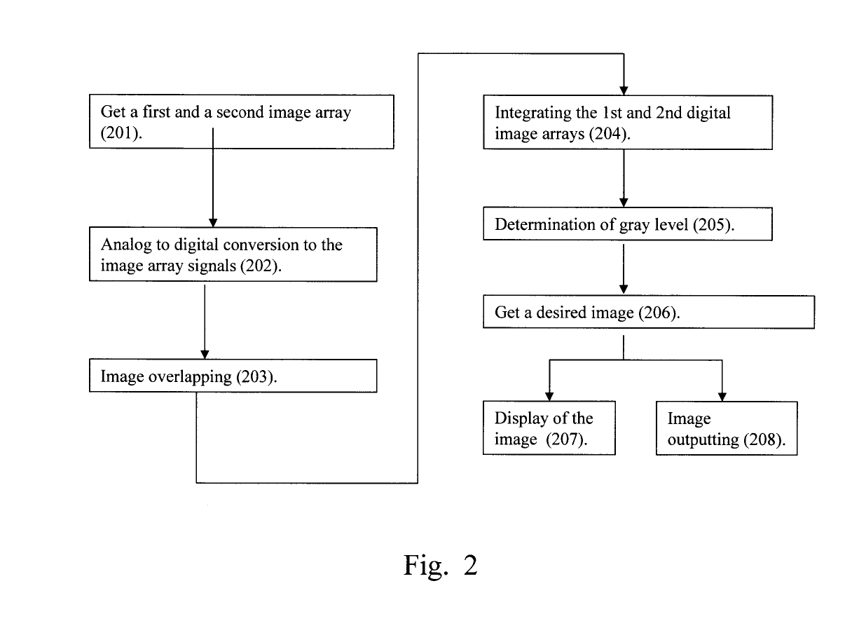

Two image sensing sets being a first image sensor array 30 and a second image sensor array 40. Each image sensor array includes a plurality of image sensors which are arranged as an array for receiving external images. Each image sensor receives a part of the image, which is a pixel of the image. An image is formed by a plurality of pixels which are arranged as an array A. The first image sensor array 30 captures an image formed as an M×N pixel array which is a first image array. The second image sensor array 40 captures an image formed as an M×N pixel array which is a second image array B (step 201, see FIG. 2).

An image signal processing module 50 receives the first image array A and the second image array B from the first image sensor array 30 and the second image sensor array 40, respectively. The image array is transferred as analog current form (or voltage form), that is, analog signals. Then image processor module 50 converts the analog signals into digital signals which are so called gray levels of respective pixels (step 202, see FIG. 2) so as to get a first digital image array and a second digital image array.

Each gray level represents the shade of a color. For a white and black color image, one of gray level is sufficient. For a colored image, three gray levels are needed, including red, green and blue. If necessary, a gray level for presenting hue of the image may be added. In the following, a single color image is used for description of the present invention, but this will not affect the scope of the present invention. The following description may be easily expanded to an image of a plurality of gray levels.

An image processor 60 is connected to the image processor module 50. The image processor 60 processes the data of the first digital image array and the second digital image array and combine the two images to have a new image with higher resolution.

The present invention further includes a memory connected to the image processor module 50 and the image processor 60 for data storage and storing related processing software.

A display 63 serves to display images from the image processor 60.

An output device 62 is connected to the image processor 60 for outputting images from the image processor 60.

The image processing way of the present invention will be described herein.

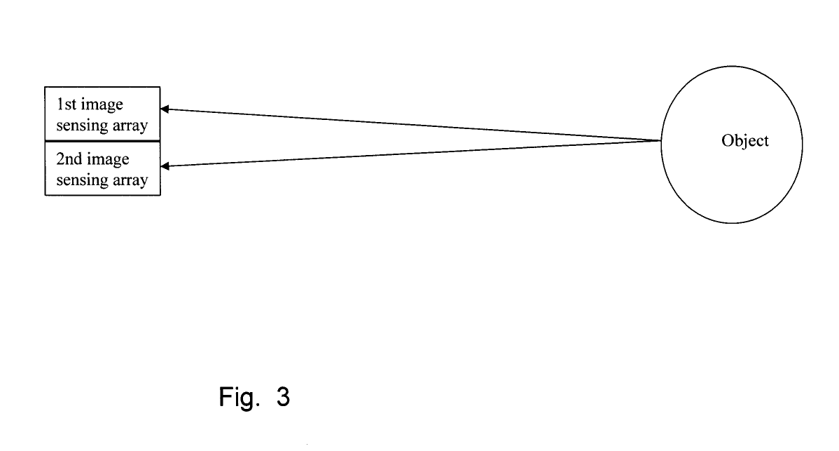

With reference to FIG. 3, in assembly state, the first image sensor array 30 and the second image sensor array 40 are placed nearly side by side. For an object located at a farther location, the aspect difference between views from the first image sensor array 30 and the second image sensor array 40 to the object is very small, but it still causes that the first digital image array and second digital image array have some difference therebetween. Thus, it is necessary to firstly overlap the first digital image array and the second digital image array exactly.

Firstly, the first digital image array is overlapped with the second digital image array (step 203, see FIG. 2). Line overlapping or surface overlapping can be used. In line overlapping, a base line is selected from the first digital image array. Each line of the second digital image array is compared with the base line so as to find a line in the second digital image array which is most similar to the base line. Then the first digital image array and the second digital image array are overlapped by overlapping the base line and the similar line.

A way for determining a line most similar to the base line can be to sum all the differences between the pixels of the base line and the corresponding pixels in the line of the second digital image array. The line in the second digital image array having the minimum summation is considered to be the line most similar to the base line.

A second way for determining a line most similar to the base line can be to sum all the squares of differences between the pixels of the base line and the corresponding pixels in the line of the second digital image array. The line in the second digital image array having the minimum summation is considered to be the line most similar to the base line.

A third way for determining a line most similar to the base line is to normalize the pixels in the base line and the lines of the second digital image array and then to sum all the products of all the pixels of the base line (after normalize) with the corresponding pixels in the line (after normalize) of the second digital image array. The line in the second digital image array having the maximum summation is considered to be the line most similar to the base line.

The way for surface overlapping is identical to those described above, but they are based on the surface (whole surface of an image or a selected part of the image). The operation is similar to above mentioned. Thus the details will not be further described herein.

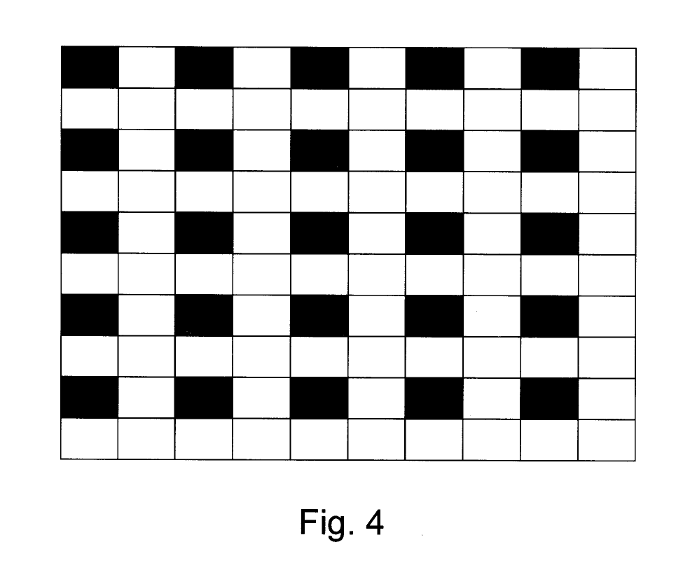

Then after overlapping, the first digital image array and the second digital image array are integrated (step 204, see FIG. 2). That is, a composite image is formed by the image processor 60. That is, the first digital image array are line-expanded by two times. Namely, a space line is interpolated to be between two lines of the first digital image array, and a space lattice is filled between two adjacent pixels in the first digital image array, as illustrated in FIG. 3. Then the second digital image array is filled into the space lines based on above mentioned overlapping way. Similarly, a space lattice is filled between two adjacent pixels in the second digital image array, but the pixels of the second digital image array are not adjacent to the pixels of the first digital image array, as illustrated in FIG. 4.

Then the space lattices are filled with gray levels (step 205 in FIG. 2). That, the gray level of the space lattice is determined based on the gray levels of the peripheral pixels. For example, the gray level of the space lattice is the average of the gray levels of the adjacent pixels. After filling all the space lattice, a processed digital image is formed.

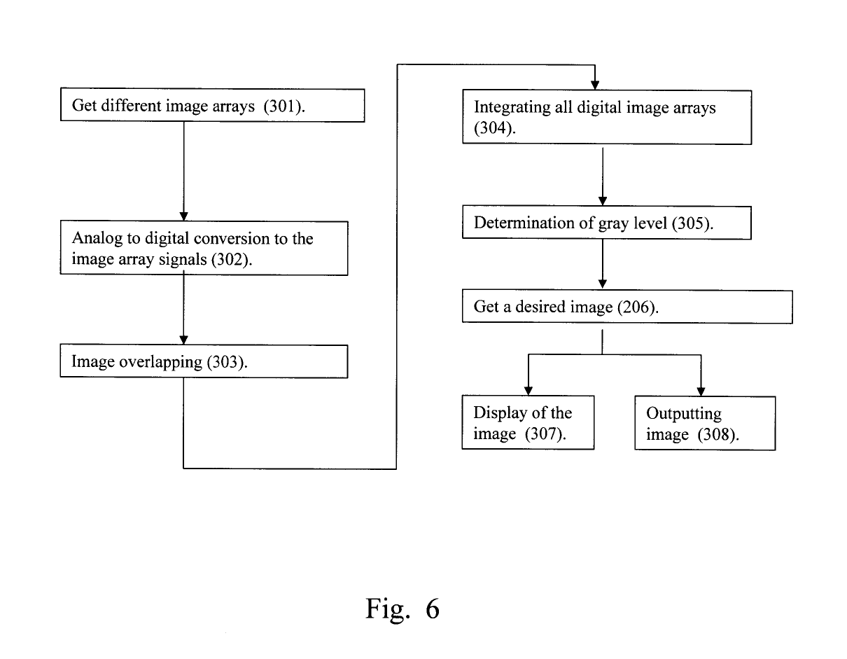

Then a desired image can be derived from the processed digital image (step 206, see FIG. 2). If required, the image can be displayed on the display 63 (step 207, see FIG. 6). The image can be outputted from the output device 62 (step 208, see FIG. 6).

It should be noted that the above mentioned structure is not used to confine the scope of the present invention. The present invention can be expanded to a camera with more than two image sensor arrays. The process for image processing in this general case will be described herein with referring to FIG. 6. A camera has at least two image sensing sets including respective image sensor arrays. Each image sensor array includes a plurality of image sensors which are arranged as an array for receiving external images. Each image sensor receives an analog signal which represents a part of the image and is view as a pixel. An image is formed by a plurality of pixels which are arranged as an array of M×N pixels (step 301, see FIG. 6); an image signal processing module serves to receive the images from the respective image sensor arrays and convert the analog signal of each pixel into a digital signal; and a value of each digital signal is a gray level of the pixel (step 302, see FIG. 6); the digital image arrays are overlapped with each other; where line overlapping or surface overlapping can be used. (step 303, see FIG. 6); after overlapping, all the digital image arrays are integrated; that is, a composite image is formed by the image processor 60; in that, the digital image arrays are expanded by filling space pixels into the pixels of the image array and then all the expanded digital image arrays are alternatively arranged (step 304, see FIG. 6); defining the gray levels of the space pixels, in that the values of the gray levels of the space pixels are determined by the gray levels of the pixels adjacent to the space pixels (step 305, see FIG. 6); Then a desired image can be derived from the processed digital image (step 306, see FIG. 6). If required, the image can be displayed on the display 63 (step 307, see FIG. 6). The image can be outputted from the output device 62 (step 308, see FIG. 6).

According to above mentioned method, the resolution of the image can be improved so as to have a high quality image. The image is finer and clear than those get from only one image sensor array. For example, conventionally, only two image sensor arrays of one million pixels can generate an image by the present invention, the image has a quality like an image generated from an image sensor array of 4 millions. However, the cost of two image sensor arrays with each array having one million sensors is very cheaper than one image sensor array of 4 millions. Thus the cost is greatly down.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A camera with at least two image sensor sets, comprising;
an aperture for receiving external light;
a lens set for capturing external images;
at least two image sensing sets each having a plurality of image sensors which are arranged as an array for receiving external images; each image sensor receives a part of the image, which is a pixel; an image is formed by a plurality of pixels which are arranged as an array of M×N pixel;
an image signal processing module receiving all the image arrays from the image sensor arrays which are presented as analog signals; the image processor module converting the analog signals into digital signals which are so called gray levels of respective pixels so as to get respectively digital image array; each gray level representing the shade of a color; and
an image processor connected to the image processor module; the image processor processing the data of the digital image arrays and combining the images to have a new image with higher resolution.

2. The camera with at least two image sensor sets as claimed in claim 1, further comprising:
a memory connected to the image processor module and the image processor for data storage and storing related processing software;
a display for displaying images from the image processor; and
an output device connected to the image processor for outputting images from the image processor.

3. The camera with at least two image sensor sets as claimed in claim 1, wherein the image processor processing the data of the digital image arrays and combining the images to have a new image with higher resolution by the steps of:
overlapping the digital image arrays with each other; where line overlapping or surface overlapping can be used;
integrating all the digital image arrays are integrated; that is, a composite image is formed by the image processor; in that, the digital image arrays being expanded by filling space pixels into the pixels of the image array and then all the expanded digital image arrays being alternatively arranged;
defining the gray levels of the space pixels, in that the values of the gray levels of the space pixels are determined by the gray levels of the pixels adjacent to the space pixels;

4. The camera with at least two image sensor sets as claimed in claim 3, further comprising the steps of:
cutting a desired image from the processed digital image;
displaying the image on the display; and
outputting the image from the output device.

5. The camera with at least two image sensor sets as claimed in claim 1, wherein when a number of the image sensor sets is two, the way for integrating the images is that:
a space line is interpolated to be between two lines of the first digital image array, and a space lattice is filled between two adjacent pixels in the first digital image array; then the second digital image array is filled into the space lines based on above mentioned overlapping way; likewise, a space lattice is filled between two adjacent pixels in the second digital image array, but the pixels of the second digital image array are not adjacent to the pixels of the first digital image array.

6. The camera with at least two image sensor sets as claimed in claim 3, wherein in line overlapping, in line overlapping, a base line is selected from the first digital image array; each line of the second digital image array is compared with the base line so as to find a line in the second digital image array which is most similar to the base line.

7. The camera with at least two image sensor sets as claimed in claim 3, wherein surface overlapping is used in the overlapping of two images.

8. The camera with at least two image sensor sets as claimed in claim 1, wherein the gray level of the space lattice is the average of the gray levels of the adjacent pixels.
